(19) United States
(12) Patent Application Publication
(10) Pub. No.: US 2010/0166216 A1
(43) Pub. Date: Jul. 1, 2010

(54) Nonlinear Signal Processing

(75) Inventors: Jonathan Arthur Chambers, Peterborough (GB); Raymond Allan Belcher, Swansea (GB); Sangarapillai Lambotharan, Leicestershire (GB)

Correspondence Address: GORDON & JACOBSON, P.C., 60 LONG RIDGE ROAD, SUITE 407, STAMFORD, CT, 06902, US

(73) Assignee: UNIVERSITY COLLEGE CARDIFF CONSULTANTS LIMITED, Cardiff (GB)

(21) Appl. No.: 12/443,219

(22) PCT Filed: Sep. 21, 2007
(86) PCT No.: PCT/GB2007/003594

§ 371 Date: Feb. 1, 2010

(30) Foreign Application Priority Data
Sep. 30, 2006 (GB) 0619320.5

(51) Int. Cl. H04B 15/00

(52) U.S. Cl. 381/94.9

(57) ABSTRACT

A method of determining a signal input to a transducer from the signal output from the transducer, the method comprising receiving as input at a processing means the signal output from the transducer, processing the signal output from the transducer in dependance upon a value for the linear gain coefficient of the transducer and a value for the quadratic nonlinear coefficient of the transducer, to determine the signal input to the transducer.

The present invention relates to the processing of signals output from transducers to remove unwanted distortion, and particularly but not exclusively, to the processing of signals output from a transducer to reduce the effects of quadratic nonlinear distortion.

Nonlinear distortion is a term used in fields such as acoustics, electronics and telecommunications, to describe the distortion between the input and output signals of, for example, an electronic device such as a transducer, due to nonlinear effects. For small input signals, the signal output from most transducers can be considered to be linearly related to the input. However, for larger input signals, the variation of the output can be nonlinearly related to the input.

In audio systems for example, a sound wave is typically generated using a loudspeaker that is driven by a signal generator and is then detected using a microphone. The loudspeaker converts the electronic signals of the generator into a sound wave. The microphone then converts the detected sound wave back into an electrical signal for processing. In such a system, the loudspeaker and microphone are the principal sources of the nonlinearity.

Nonlinearity is generally unwanted in most situations as it can lead to the generation of additional frequencies within the desired signal, which can degrade the desired output signal through interference. Unfortunately, nonlinear signal distortion is inherent to many electronic devices since the origin of this distortion lies within their fundamental components, namely the active and passive components such as transistors and resistors. Consequently, nonlinear distortion is prevalent in many electronic systems.

Systems comprising the known art compensate for the nonlinearity introduced by a loudspeaker and microphone utilising the knowledge of the input signal and the measured output signal. However, in practical systems in which the input signal is an unknown combination of frequencies and waveforms, for example as in speech, and only the output signal can be measured, it has been found difficult to mitigate the quadratic nonlinearity introduced by the microphone and thus the input signal.

The quadratic nonlinearity refers to the component of the signal output of a transducer which varies as the square of the input signal. Known methods for processing an output signal of a transducer to compensate for quadratic distortion can only approximately correct for the quadratic distortion. In one such method, the measured output signal y(t) is assumed as being approximately equal to the input signal x(t), such that the compensated input signal can be determined according to the relationship x(t)=y(t)−by²(t), where b is the quadratic nonlinear coefficient of the microphone. As this method relies on the approximation x(t)≈y(t), there is always an error in the calculation of x(t).

It is an aim of the present invention to improve upon such methods.

In accordance with this invention as seen from a first aspect there is provided a method of determining a signal input to a transducer from the signal output from the transducer, the method comprising receiving as input at a processing means the signal output from the transducer, processing the signal output from the transducer in dependance upon a value for the linear gain coefficient of the transducer and a value for the quadratic nonlinear coefficient of the transducer, to determine the signal input to the transducer.

In accordance with this invention as seen from a second aspect there is provided a processor for determining a signal input to a transducer from the signal output from the transducer, the processor comprising means for receiving as an input signal the signal output from a transducer, and processing means for processing the signal output from the transducer in dependance upon a value for the linear gain coefficient of the transducer and a value for the quadratic nonlinear coefficient of the transducer, to determine the signal input to the transducer.

Preferably, the processing is performed by solving a polynomial equation having as known terms values for the linear gain coefficient, the quadratic nonlinear coefficient and the signal output of the transducer.

Preferably, the processing is performed in accordance with the relationship:

x(t)=±[y(t)/b+(a/2b)²]^{1/2}−(a/2b)

where a is a value of the linear gain coefficient of the transducer, b is a value of the quadratic nonlinear coefficient of the transducer, y(t) is a value of the signal output from the transducer and x(t) represents a value of the input signal to be determined, and wherein the value of x(t) is selected as +[y(t)/b+(a/2b)²]^{1/2}−(a/2b), or as −[y(t)/b+(a/2b)²]^{1/2}−(a/2b).

Preferably, the value of x(t) is selected according to the inequality

$$if$$

$$\begin{matrix}min [ x ( t ) ] \geq ( - a / 2 b ) & then & x ( t ) = {[ y ( t ) / b + {( a / 2 b )}^{2} ]}^{1 / 2} - ( a / 2 b ) \\ min [ x ( t ) ] < ( - a / 2 b ) & then & x ( t ) = - {[ y ( t ) / b + {( a / 2 b )}^{2} ]}^{1 / 2} - ( a / 2 b )\end{matrix}$$

An embodiment of the present invention will now be described by way of example only and with reference to the accompanying drawings, in which

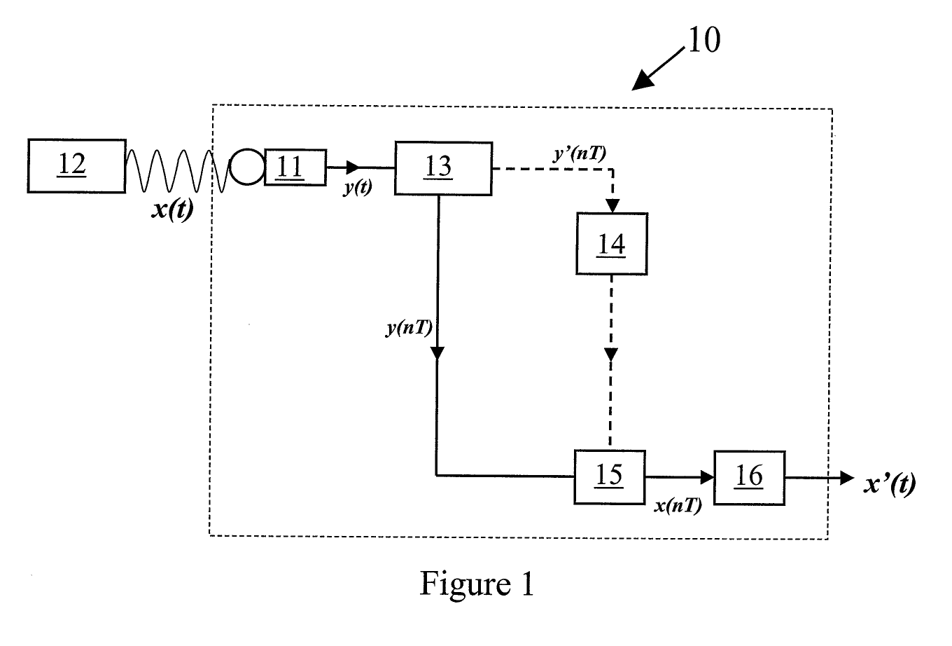

FIG. 1 illustrates a schematic representation of a signal processing system embodying the present invention; and,

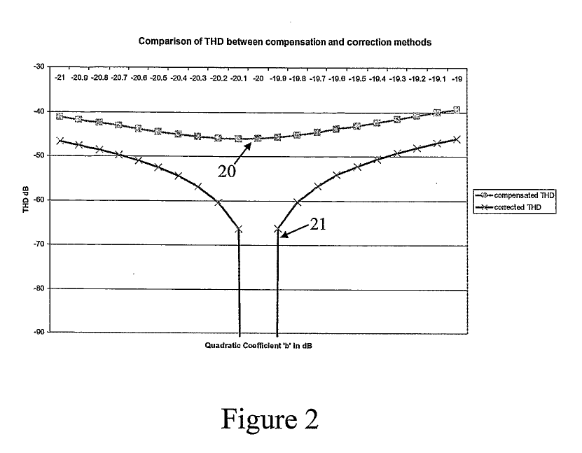

FIG. 2 is a graphical comparison of the results of a prior art method and a method embodying the present invention for reducing the effects of quadratic nonlinear distortion.

Referring to FIG. 1, a system 10 comprises a microphone 11 having an output connected to the input of an analogue-to-digital converter (ADC) 13. The ADC 13 in turn has an output connected to a first processing unit 14. A sounding source 12, for example a high quality loud speaker without significant nonlinear distortion, generates a test sound signal x(t) that is input to the microphone 11. The resultant electrical output y(t) of the microphone 11 is digitised by the ADC 13 to generate digitised signal y′(nT). The processing unit 14 processes the digitised signal y′(nT) to determine values for the linear gain coefficient and the quadratic nonlinear coefficient of the microphone 11.

The system 10 further comprises a second processing unit 15 (subsequent to the first processing unit 14). The second processing unit 15 is arranged to receive a signal output from the ADC 13 and to process the signal to generate a digital signal x(nT) that accurately approximates an analogue input signal of the microphone 11. The digitised signal x(nT) is then converted to an analogue electronic signal x′(t) by a digital-to-analogue converter (DAC) 16. Thus, the second processing unit 15 processes the signal input from the ADC 13 to substantially remove or reduce the quadratic nonlinear distortion introduced by the microphone 11.

As will be explained in more detail below, the second processing unit 15 processes the input signal using the values of the linear gain coefficient and the quadratic nonlinear coefficient, as determined by the first processing unit 14, to generate the data representing a signal input to the microphone.

It is envisaged that the linear gain coefficient and the quadratic nonlinear coefficient of the microphone will be determined under test conditions in the factory where the microphone 11 is manufactured. Subsequently, the second processing unit 15 can then be programmed so as to be able to process input signals y(nT) in dependence upon the determined value of the quadratic nonlinear coefficient and a value for the linear gain of the microphone 11, to generate the undistorted microphone 11 output x′(t).

The microphone 11, the ADC 13, the first and second processing units 14, 15, and the DAC 16, may then be sold for use as a single unit 10, which corrects for quadratic nonlinear distortion in signals output from the microphone 11.

The mathematics underpinning the processing performed by the first processing unit 14 and the second processing unit 15 are as follows:

The output y(t) of a microphone, is generally, a function of the input signal x(t) and can be represented using the model,

y(t)=ax(t)+b(x(t))², (1)

where a is the linear gain and b is the quadratic nonlinear coefficient of the microphone 11, which are collectively termed the model coefficients. The model coefficients are indicative of the relative contribution of the respective linear and nonlinear components to the output signal y(t), as described above.

In practical systems it is possible to measure y(t), however, it is often difficult to ascertain the exact input signal x(t). The presence of the quadratic nonlinear term in equation 1, i.e. b(x(t))², degrades the output signal y(t), which in an ideal system, would be a scalar multiple of the input x(t). Accordingly, the ability to correct the output signal to correct for the undesired quadratic nonlinear component would allow for an accurate determination of the input signal x(t).

For the purposes of describing the present invention, it is assumed that the input signal x(t) is a simple sinusoidal waveform having a single frequency ω and amplitude A. However, the method of the present invention could be applied to any waveform having any number of frequency components.

Substituting the assumption x(t)=A.sin(ωt) in equation 1, it is found that,

y(t)=a.A.sin(ωt)+b A².sin²(ωt), (2)

and using the trigonometric identity,

cos(2ωt)=1−2 sin²(ωt), (3)

it is found that,

y(t)=b.A²/2+a.A sin(ωt))−(b.A²/2)cos(2 ωt). (4)

From equation 4, it is evident that the application of a single harmonic, i.e. single frequency (ω), to a quadratic nonlinear system, can lead to the generation of a higher harmonic (2ω), which can degrade the output signal. In addition, the microphone 11 is found to generate a component having zero frequency, namely b.A²/2—the dc component.

Applying a discrete Fourier transform, (which as is well known, relates the time domain of a signal to the frequency domain) to equation 4, the amplitude of the fundamental harmonic is found to be

(a.A) (5)

and the amplitude of the second harmonic is found to be

(b.A²/2). (6)

In the factory context, the value of A would be known, as would the characteristics of the ADC 13. Therefore, using equation 5 and 6, the values of a and b can be determined.

Now, using equation 1 and the identity (x(t)+a/2b)²=x(t)²+(a/b).x(t)+(a/2b)², the output of a system having a quadratic nonlinearity can be represented as

y(t)=b((x(t)+a/2b)²−(a/2b)²), (7)

which can be rearranged to find the input x(t) as

x(t)=±[y(t)/b+(a/2b)²]^{1/2}−(a/2b). (8)

This gives two possible solutions for x(t), namely

x(t)=[y(t)/b+(a/2b)²]^{1/2}−(a/2b) (9)

x(t)=−[y(t)/b+(a/2b)²]^{1/2}−(a/2b) (10)

In practice, there is ambiguity as to whether to use equation 9 or 10, as x(t) is unmeasurable. However, since the linear gain coefficient and the quadratic nonlinear coefficient of the microphone 11 satisfy the conditions that a>0, b>0, and assuming (a/2b)>>1 and that x(t) has a zero average during normal use, then provided that the minimum value of x(t),

minx(t)]≧(−a/2b), (11)

the calculation of x(t) proceeds via equation 9. Alternatively, if

minx(t)]<(−a/2b), (12)

the calculation of x(t) proceeds using equation 10.

Referring again to FIG. 1, to determine a and b, the output signal y(t) from the microphone 11 is passed to the ADC 13 which produces a discrete sample of the analogue signal y(t) at periodic time intervals T and generates the digital signal y(nT), where n is an integer. In the factory context, where likely ranges on a and b are available, the microphone input signal would be designed so that y(nT) lies within the full scale range of the ADC 13. This digital signal is then passed to the first processing unit 14 which applies a discrete Fourier transform to the signal to generate values for a.A and b.A²/2. Using a known or measured value for A, the first processing unit 14 calculates a value for a and a value for b.

Once the values for a and b have been calculated, the second processing unit 15 is arranged so that it can subsequently process signals output from the ADC according to equation 9 or 10, to calculate the corresponding undistorted signal input to the microphone 11. The second processing unit 15 is arranged to apply the inequalities 11 and 12 to select which of equations 9 and 10 is to be used to calculate the undistorted signal.

It is envisaged that processor 10, namely the ADC 13, the first and second processing units 14, 15 and the DAC 16 are realised on a digital signal processing chip or card and housed within the microphone 11. The values for a and b will be determined at manufacture and the second processing unit 15 then arranged to perform the operation of equation 9 and 10. Post sale, such a processing chip could then be utilised to minimise the quadratic nonlinear distortion in a signal output from the microphone 11, during any subsequent use of the microphone 11.

It is further envisaged that the calibration of the processor 10 to correct for quadratic nonlinear distortion of the microphone 11, could be selectively performed by a user following manufacture, to re-calibrate the processor 10 to accommodate for any degradation of the device 11.

Embodiments of the present invention remove the quadratic distortion by solving an exact equation for x(t). The advantage this provides is confirmed with reference to FIG. 2, which shows a plot of the total harmonic distortion (THD) against the assumed value of the quadratic nonlinear coefficient, b, on a decibel (dB) scale, for both a prior art compensation method 20 described in the introduction and a method embodying the present invention 21. The THD is defined as the ratio of total power created by the nonlinear component to the total power of the fundamental component. Accordingly, on a logarithmic scale, a perfect correction for the nonlinear quadratic component would reveal a value of THD which tends to −∞, since the perfect correction is one whereby the total power of the nonlinear quadratic component is zero.

From FIG. 2 it is evident that the embodiment of the method of the present invention is always better than the approximation technique described in the introduction. Assuming the exact value of b can be determined for a particular microphone (around −20 dB for the example in FIG. 2), then a perfect correction for quadratic nonlinear distortion can be achieved. Even if non exact values for b are used, FIG. 2 demonstrates that embodiments of the present invention still provide improved results over the prior art. Typical sounding sources used to produce the test signal for the determination of b will also typically produce some quadratic nonlinear distortion and so the calculation of b will also be influenced by the sounding source, resulting in incorrect values of b. Nevertheless, the use of high quality sounding sources can minimise the contribution to b from the sounding source and thereby optimise the correction for the quadratic distortion produced by the microphone.

While the specific embodiment described here refers to a microphone transducer, it is appreciated that the invention could be used with other types of transducer.

1. A method for use with a transducer that converts an input signal into an output signal, the method for generating a signal representative of the input signal comprising:
receiving as input at a processing means the output signal generated by the transducer; and
processing the output signal generated by the transducer at the processing means in dependance upon a value for the linear gain coefficient of the transducer and a value for the quadratic nonlinear coefficient of the transducer, to generate a signal representative of the input signal.

2. A method according to claim 1, wherein the processing of the output signal generated by the transducer is performed by solving a polynomial equation having as known terms values for the linear gain coefficient, the quadratic nonlinear coefficient and the output signal of the transducer.

3. A method according to claim 2, wherein said polynomial equation is a quadratic equation.

4. A method according to claim 1, wherein the processing of the output signal generated by the transducer is performed in accordance with the relationship:
x(t)=±[y(t)/b+(a/2b)²]^{1/2}−(a/2b)
where a is a value of the linear gain coefficient of the transducer, b is a value of the quadratic nonlinear coefficient of the transducer, y(t) is a value of the output signal of the transducer and x(t) represents a value of the signal representative of the input signal to be determined, and wherein the value of x(t) is selected as +[y(t)/b+(a/2b)²]^{1/2}−(a/2b), or as −[y(t)/b+(a/2b)²]^{1/2}−(a/2b).

5. A method according to claim 4, wherein the value of x(t) is selected in dependance upon a comparison between a minimum obtained value of x(t) with a quantity that depends upon a ratio of the linear gain coefficient and the quadratic nonlinear coefficient.

6. A method according to claim 4, wherein the value of x(t) is selected according to the inequality
$$If$$
$$\begin{matrix}min [ x ( t ) ] \geq ( - a / 2 b ) & then & x ( t ) = {[ y ( t ) / b + {( a / 2 b )}^{2} ]}^{1 / 2} - ( a / 2 b ) \\ min [ x ( t ) ] < ( - a / 2 b ) & then & x ( t ) = - {[ y ( t ) / b + {( a / 2 b )}^{2} ]}^{1 / 2} - ( a / 2 b )\end{matrix}$$

7. A method according to claim 1, further comprising converting the output signal generated by the transducer from an analogue signal to a digital signal using an analogue-to-digital converter.

8. A method according to claim 1, wherein the transducer comprises a microphone.

9. A method according to claim 1, wherein the linear gain coefficient and the quadratic nonlinear gain coefficient are determined using Fourier analysis.

10. A processor for use with a transducer that converts an input signal into an output signal, the processor for generating a signal representative of the input signal comprising:
means for receiving the output signal generated by the transducer; and
processing means for processing the output signal generated by the transducer in dependance upon a value for the linear gain coefficient of the transducer and a value for the quadratic nonlinear coefficient of the transducer, to generate a signal representative of the input signal.

11. A processor according to claim 10, wherein the processing of the output signal generated by the transducer is performed by solving a polynomial equation having as known terms values for the linear gain coefficient, the quadratic nonlinear coefficient and the output signal of the transducer.

12. A processor according to claim 11, wherein said polynomial equation is a quadratic equation.

13. A processor according to claim 10, wherein the processing of the output signal generated by the transducer is performed in accordance with the relationship:
x(t)=±[y(t)/b+(a/2b)²]^{1/2}−(a/2b)
where a is a value of the linear gain coefficient of the transducer, b is a value of the quadratic nonlinear coefficient of the transducer, y(t) is a value of the output signal of from the transducer and x(t) represents a value of the signal representative of the input signal to be determined, and wherein the value of x(t) is selected as +[y(t)/b+(a/2b)²]^{1/2}−(a/2b), or as −[y(t)/b+(a/2b)²]^{1/2}−(a/2b).

14. A processor according to claim 13, comprising means for selecting the value of x(t) in dependence upon a comparison between a minimum obtained value of x(t) with a quantity that depends upon a ratio of the linear gain coefficient and the quadratic nonlinear coefficient.

15. A processor according to claim 13, wherein the value of x(t) is selected according to the inequality
$$if$$
$$\begin{matrix}min [ x ( t ) ] \geq ( - a / 2 b ) & then & x ( t ) = {[ y ( t ) / b + {( a / 2 b )}^{2} ]}^{1 / 2} - ( a / 2 b ) \\ min [ x ( t ) ] < ( - a / 2 b ) & then & x ( t ) = - {[ y ( t ) / b + {( a / 2 b )}^{2} ]}^{1 / 2} - ( a / 2 b )\end{matrix}$$

16. A processor according to claim 10, further comprising an analogue-to-digital converter for converting an analogue signal output from the transducer into a digital signal.

17. A processor according to claim 10, further comprising means for determining the linear gain coefficient and the quadratic nonlinear gain coefficient using Fourier analysis.

18-20. (canceled)

21. An apparatus comprising:
a transducer that converts an input signal into an output signal; and
processor means for generating a signal representative of the input signal, the processor means including
means for receiving the output signal generated by the transducer, and
processing means for processing the output signal generated by the transducer in dependance upon a value for the linear gain coefficient of the transducer and a value for the quadratic nonlinear coefficient of the transducer, to generate a signal representative of the input signal.

22. An apparatus according to claim 21, wherein:
the processing of the output signal generated by the transducer is performed in accordance with the relationship:
x(t)=±[y(t)/b+(a/2b)²]^{1/2}−(a/2b)
where a is a value of the linear gain coefficient of the transducer, b is a value of the quadratic nonlinear coefficient of the transducer, y(t) is a value of the output signal of the transducer and x(t) represents a value of the signal representative of the input signal to be determined, and wherein the value of x(t) is selected as +[y(t)/b+(a/2b)²]^{1/2}−(a/2b), or as −[y(t)/b+(a/2b)²]^{1/2}−(a/2b).

23. An apparatus according to claim 21, wherein:
the transducer comprises a microphone.
